(19) United States
(12) Patent Application Publication
(10) Pub. No.: US 2023/0308581 A1
(43) Pub. Date: Sep. 28, 2023

(54) IMAGE PROCESSING APPARATUS, METHOD OF CONTROLLING IMAGE PROCESSING APPARATUS, AND STORAGE MEDIUM

(71) Applicant: CANON KABUSHIKI KAISHA, Tokyo (JP)

(72) Inventor: YOKO TAKENAKA, Chiba (JP)

(21) Appl. No.: 18/186,744

(22) Filed: Mar. 20, 2023

(30) Foreign Application Priority Data
Mar. 24, 2022 (JP) 2022-048092

(51) Int. Cl. H04N 1/32

(52) U.S. Cl. CPC H04N 1/3208; H04N 1/3239; H04N 2201/3235

(57) ABSTRACT

When an image forming apparatus receives a data from a FAX, the image forming apparatus posts, to a chat service, a message indicating that the data is received from the FAX. If an F-code is set for the data received from the FAX, the image forming apparatus posts, to the chat service, a message that requires inputting a password, and posts, to the chat service, a message indicating the content of the received data based on the password received via the chat service.

### BACKGROUND OF THE DISCLOSURE

### Field of the Disclosure

The present disclosure relates to an image processing apparatus comprising a function receiving data from a facsimile, a method of controlling the image processing apparatus, and a storage medium.

### Description of the Related Art

Some image processing apparatuses have a function to notify a notification destination such as a pre-registered email address of received information in response to receiving data from a facsimile (hereinafter referred to as “FAX”). However, the function notifies information unilaterally. If instructing other FAX processing, a user cannot set an instruction to process the data from the FAX to the image forming apparatus when the user is away from the image forming apparatus because the user has to set the instruction to the image processing apparatus via the operation unit of the image processing apparatus.

Japanese Patent Application Laid-Open No. 2021-064919 discloses a technology that uses a chat application on a terminal device to notify reception and issue processing instructions when receiving data from the FAX. In the chat application, it is possible to display received information and received images and to issue processing instructions, such as forwarding the received data.

When receiving data from the FAX that requires to input a password to view content of the data, some image processing apparatus have a function to input the password from the operation unit of the image processing apparatus and make the received data viewable only if the input password matches a preset password. Other image processing apparatus have a function to ask the user to input the password if forwarding data received from the FAX. There is no cooperation with network communication services, such as chat application, for functions that require the input of authentication information, such as a password, for processing after receiving data from the FAX. For example, the content of the data from the FAX with a password setting can not be confirmed even if receipt notification can be confirmed by the chat application. It should be noted that in the disclosure of Japanese Patent Application Laid-Open No. 2021-064919, the received data from the FAX is displayed in the chat application if the data is received from the FAX. However, if the received data from the FAX, which is supposed to be viewable after input of the password, is displayed in the chat application without input of the password, as in Japanese Patent Application Laid-Open No. 2021-064919, a disinterested person unauthorizedly views the received data and security risks increase.

### SUMMARY OF THE DISCLOSURE

Embodiments of the present disclosure are made to solve the above issues. The purpose of embodiments of the present disclosure is providing a scheme for improving usability by solving security issues in the image processing apparatus cooperated with the network communication service.

According to embodiments of the present disclosure, an image processing apparatus receiving data from a facsimile comprises one or more memories and one or more processors that execute instructions to post, to a message communication service, a message indicating that the data is received, and perform processing of the data received from the facsimile, wherein a message requiring an input of authentication information is posted according to a condition, wherein the processing of the data is performed based on the authentication information received via the message communication service.

Further features of the present disclosure will become apparent from the following description of exemplary embodiments with reference to the attached drawings.

### BRIEF DESCRIPTION OF THE DRAWINGS

FIG. 1 illustrates an example showing a configuration of a reception notification system according to the present embodiment.

FIG. 2 illustrates an example showing a configuration of an imaging apparatus according to the present embodiment.

FIG. 3 illustrates an example showing a configuration of a chat server according to the present embodiment.

FIG. 4 illustrates an example showing a configuration of a terminal apparatus according to the present embodiment.

FIG. 5 illustrates a flowchart showing the processing of the image forming apparatus during receiving the data from the FAX according to the first embodiment.

FIG. 6 illustrates a flowchart showing the processing of the image forming apparatus during receiving password input notification according to the first embodiment.

FIG. 7 illustrates a diagram showing a screen for setting chat application notification settings in the image forming apparatus.

FIG. 8A illustrates a diagram showing a chat application screen according to the first embodiment.

FIG. 8B illustrates a diagram showing a chat application screen according to the first embodiment.

FIG. 8C illustrates a diagram showing a chat application screen according to the first embodiment.

FIG. 9A illustrates a diagram showing a sequence of processing according to the first embodiment.

FIG. 9B illustrates a diagram showing a sequence of processing according to the first embodiment.

FIG. 10 illustrates a flowchart showing the processing of the image forming apparatus during receiving the data from the FAX according to the second embodiment.

FIG. 11 illustrates a flowchart showing the processing of the image forming apparatus during receiving password input notification according to the second embodiment.

FIG. 12A illustrates a diagram showing the chat application screen according to the second embodiment.

FIG. 12B illustrates a diagram showing the chat application screen according to the second embodiment.

FIG. 12C illustrates a diagram showing the chat application screen according to the second embodiment.

FIG. 13A illustrates a diagram showing the sequence of processing according to the second embodiment.

FIG. 13B illustrates a diagram showing the sequence of processing according to the second embodiment.

FIG. 14A illustrates a diagram showing a screen related to the FAX function of the image forming apparatus.

FIG. 14B illustrates a diagram showing a screen related to the FAX function of the image forming apparatus.

FIG. 15A illustrates a diagram showing a screen related to the private box of the image forming apparatus.

FIG. 15B illustrates a diagram showing a screen related to the private box of the image forming apparatus.

### DESCRIPTION OF THE EMBODIMENTS

Embodiments of the present disclosure will be described in detail below with reference to the drawings.

### First Embodiment

In the first embodiment, when an image forming apparatus receives data with an F-code setting from a facsimile apparatus, the image forming apparatus notifies a chat application in a terminal device of information that the data is received and notification of password confirmation. In the password confirmation, if an input password matches a predetermined password via the chat application, the image forming apparatus displays contents of the received data from the facsimile. Hereafter, “facsimile” is also referred to as “FAX”, “fax”, or “fax”. The “F-code” will be described later.

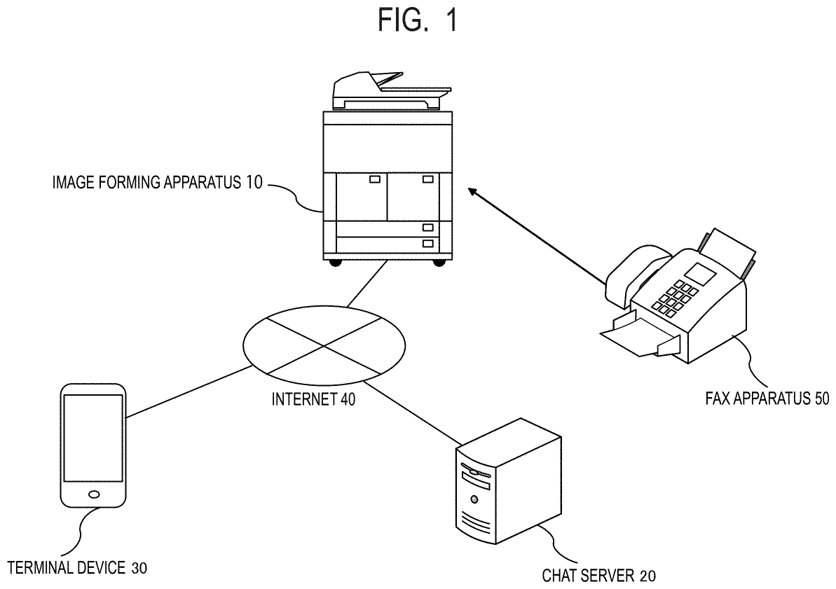

FIG. 1 illustrates an example showing a configuration of a FAX reception notification system according to the present embodiment in the present disclosure. The FAX reception notification system in the present embodiment comprises an image forming apparatus 10, a chat server 20, and a terminal device 30.

The image forming apparatus 10, the chat server 20, and the terminal device 30 are connected via an internet 40. In this system, an external FAX apparatus 50 and the image forming apparatus 10 are connected via a PSTN (Public Telephone Network) to enable FAX transmission and reception. In the present embodiment, the FAX apparatus 50 transmits the data to the image forming apparatus 10. The image forming apparatus 10 and the FAX apparatus 50 may be connected via the internet 40 for FAX transmission and reception.

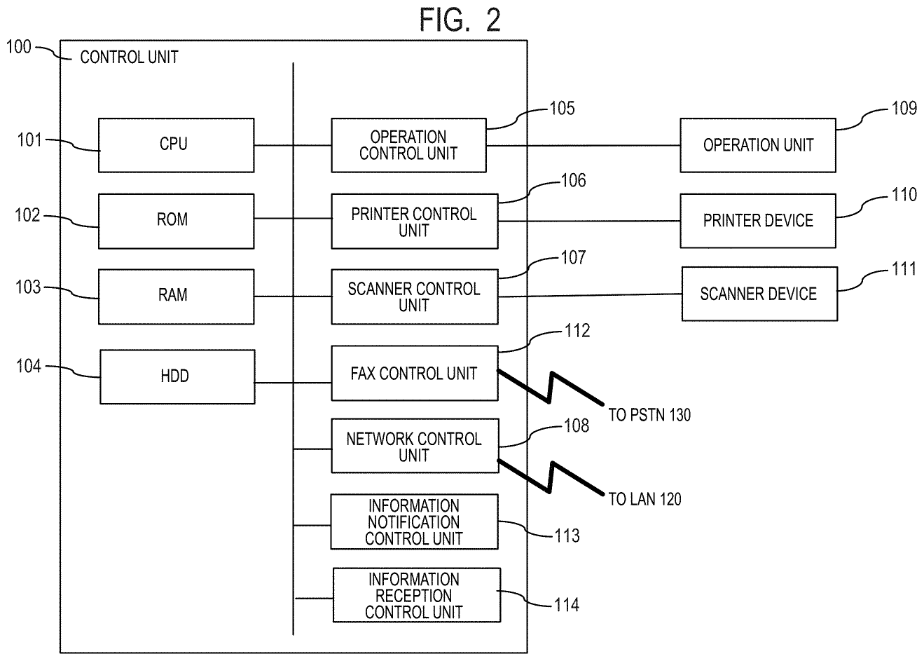

FIG. 2 illustrates an example showing a configuration of the image forming apparatus 10. A control unit 100 including a CPU 101 controls the operation of the entire image forming apparatus 10. The CPU 101 reads control programs stored in a ROM 102 to perform various controls such as read control and transmission control. The ROM 102 is a boot ROM and stores a boot program of the system. A RAM 103 is used as a temporary storage area such as a main memory and work area of the CPU 101.

An HDD (Hard Disk Drive) 104 stores image data, various programs, or various information tables. The HDD 104 is also used for storing scanned documents and the like, and for temporarily storing FAX data received from the FAX apparatus 50. Other storage apparatus such as an SSD (Solid State Drive) may be provided instead of or in combination with the HDD 104.

An operation control unit 105 is an interface for connecting an operation unit 109 and the control unit 100. The operation unit 109 includes a liquid crystal display unit with a touch panel function, a keyboard, and the like. A printer control unit 106 is an interface for connecting a printer 110 and the control unit 100. Image data to be printed by the printer 110 is transmitted from the control unit 100 via the printer control unit 106 and printed on a recording medium (on paper) by the printer 110. A scanner control unit 107 is an interface for connecting a scanner 111 and the control unit 100. The scanner 111 scans images on documents to generate image data and inputs the image data to the control unit 100 via the scanner control unit 107.

A FAX control unit 112 is connected to a telephone line such as a PSTN 130 and the like and transmits/receives the FAX data to/from other FAX apparatus 50 via the telephone line. That is, the image forming apparatus 10 is an image processing apparatus with functions of receiving to/from the FAX.

If the FAX control unit 112 transmits the FAX data, a FAX transmission processing is performed in response to setting the document in the scanner 111 and operating the FAX transmission processing via the operation unit 109. Then, when the communication procedure with the other unity is possible, sequential transmission processing is performed to the other unity via a communication line. If the FAX control unit 112 receives the FAX data, the FAX control unit 112 acquires received information to store the received information in the HDD 104 while the FAX control unit performs communication processing. The received information acquired is, for example, telephone number information, TSI (Transmitting Subscriber Identification Signal), received time, and received image. In the image forming apparatus 10, image data is subjected to various types of image processing as needed, and is output from the printer 110 via the printer control unit 106.

An information notification control unit 113 analyzes the received information received from the FAX apparatus 50 to create received notification information, and notifies the terminal device 30 via the chat server 20. An information reception control unit 114 receives the password input by the user with the terminal device 30 via the chat server 20. The information notification control unit 113 and the information reception control unit 114 are realized when, for example, the CPU 101 reads and executes control programs stored in the ROM 102 or the like.

A network control unit 108 is an interface for connecting the control unit 100 to LAN 120. The network control unit 108 transmits and receives information to external apparatuses connected to the internet 40 via the LAN 120.

The functions of the image forming apparatus 10 are described below. Typical functions (applications) of the image forming apparatus 10 are as follows.

(a) A function “copy” that scans the images on the document by the scanner 111 and prints the generated image data by the printer 110.
(b) A function “print” that prints image data by the printer 110 based on a print job transmitted from an external apparatus such as a client PC.
(c) A function “scan and transmit” that scans the images on the document by the scanner 111 and transmits the generated image data to the external apparatuses and the like from the network control unit 108.
(d) A function “scan and store” that scans the images on the document by the scanner 111 and stores the generated image data in the HDD 104.
(e) A function “use stored file” that prints the image data stored in the HDD 104 by the printer 110 or transmits the image data to the external apparatuses and the like via the network control unit 108.
(f) A function “browser” that views, prints, and stores data on a web server via a web browser.
(g) A function “FAX” that transmits and receives the documents to and from the FAX apparatus 50 via the telephone line.

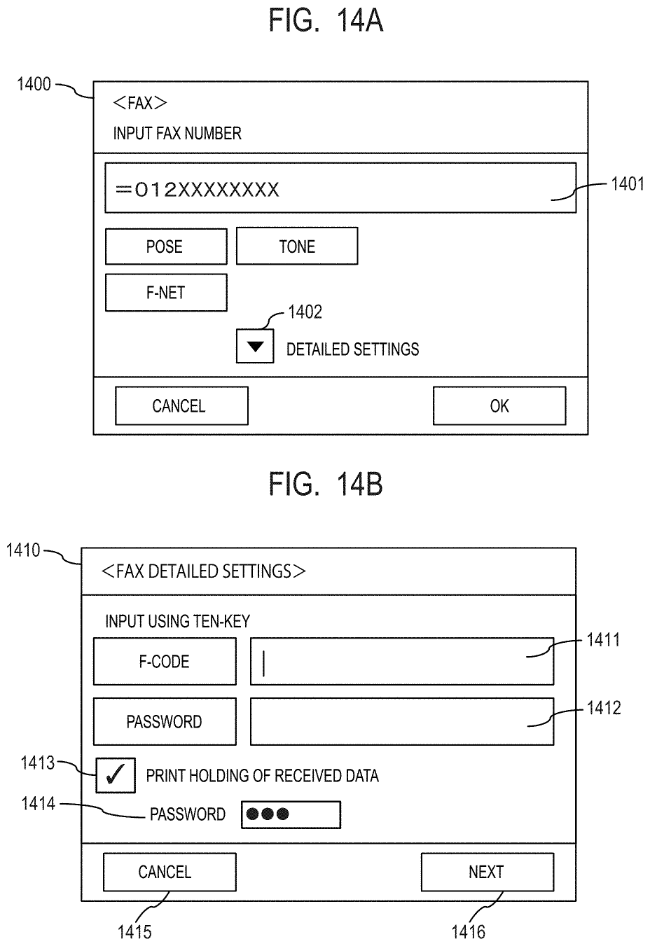

An example of a screen in the FAX function according to the present embodiment will be described with reference to FIGS. 14A and 14B. FIG. 14A illustrates an example showing a FAX setting screen 1400 displayed when the FAX function (FAX application) is activated by the user via the operation unit 109 of the image forming apparatus 10.

In the FAX setting screen 1400, a destination number input field 1401 is for inputting a destination telephone number to transmit the FAX data. A detailed setting 1402 is an item to be selected when the user sets the detailed settings related to the FAX function. When the detailed setting 1402 is selected, the image forming apparatus 10 displays a FAX detail setting screen 1410.

In the FAX detail setting screen 1410, there are input items of F-code 1411 and password 1412 to be set when transmitting privately using F-code. When the image forming apparatus 10 receives the data with F-code 1411 and password 1412 from the FAX, the data from the FAX is stored in a memory such as a private box. Note that the FAX detail setting screen 1410 may have items related to other FAX functions not described in the present embodiment. The print holding 1413 of the received data and password 1414 will be described later.

Here, the functions related to the private box will be described. In the private box, among the data received from the FAX, the received data from the FAX in which a sub-address included in the SUB signal in accordance with ITU-T Recommendation T. 30 and the password included in the PWD signal are specified is stored. The “sub-address” is called the “F-code” and is written as “F-code” in the present embodiment. If the F-code notified by the FAX apparatus at the time of receiving the data from the FAX matches the F-code preset in the private box as described later, the received data from the FAX is stored in the private box. If the user views the received data in the private box, the user is required to input the password preset in the private box. If the received data includes the F-code setting, the received data from the FAX is stored in the private boxes provided separately for each F-code, and the user is required to input the password if viewing the received data from the FAX.

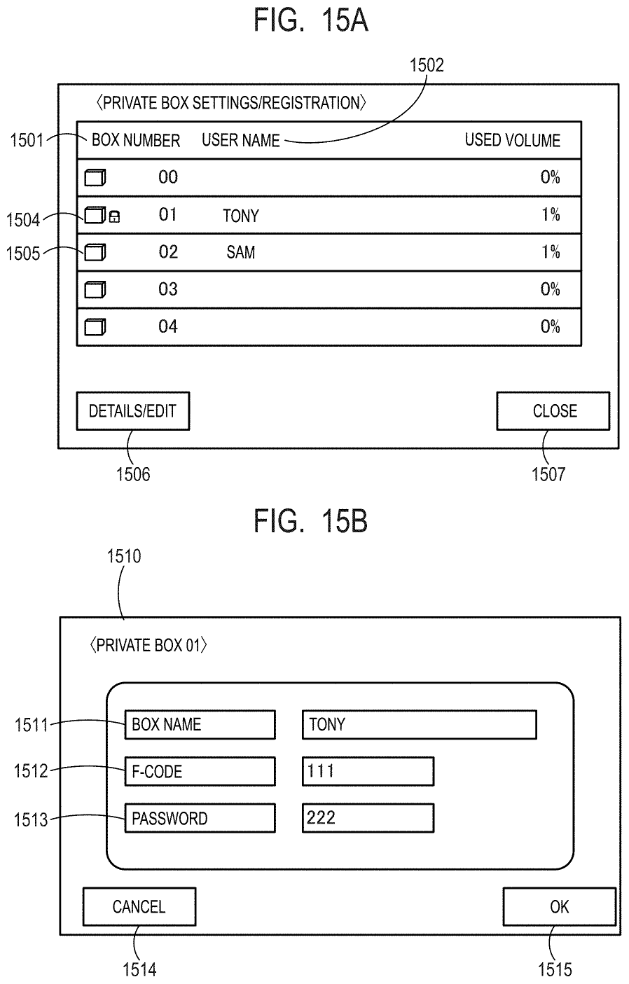

FIG. 15A illustrates an example showing the setting/registration screen of the private box displayed on the operation unit 109. In FIG. 15A, in a setting/registration screen of the private box, private box number 1501, private box name 1502, and the like are displayed as a list of private boxes. For example, box name “Tony” is registered in the private box number “01” as shown in 1504. Similarly, box name “Sam” is registered in the private box number “02” as shown in 1505.

If the user selects any private box from the list of the private boxes on the setting/registration screen of the private box and presses the “details/edit” button 1506, the detailed setting screen of the selected private box is changed to a screen shown in FIG. 15B from the screen shown in FIG. 15A. If the user presses the “close” button 1507, the screen shown in FIG. 15A is closed.

FIG. 15B illustrates an example showing the detail setting screen 1510 of the private box, which is displayed after the user selects a record 1504 on the setting/registration screen of the private box and presses the “details/edit” button 1506.

In the detail setting screen 1510 of the private box illustrated in FIG. 15B, an on-screen keyboard is displayed by selecting a box name 1511, and the user can input and register the private box name. In addition, the user can select an F-code 1512 to input alphanumeric characters and the like and register the F-code with a maximum of 20 digits. In addition, the user can select a password 1513 to input alphanumeric characters and register the password with a maximum of 20 digits.

If the user presses the “cancel” button 1514 on the detail setting screen 1510 of the private box, the screen is changed to the setting/registration screen of the private box without storing the information of the private box name, box password, F-code, and password input by the user. If the user presses the “OK” button 1515, the information input by the user is stored in the HDD 104 or the like, and the screen is changed to the setting/registration screen of the private box.

The user inputs the password when the user selects the private box, and only when the input password matches the password 1513 previously set in the detail setting screen of the private box, the user can view the received data stored in the private box. Note that the setting/registration screen of the private box or the detail setting screen 1510 of the private box may have items related to other FAX functions not described in the present embodiment. When the setting/registration of the private box set as described above is performed, the setting/registration value is stored in the HDD 104 or the like.

Hereafter, a description returns to the FAX functions. In addition, the fax functions (fax application) have a function to store received data in a memory such as HDD 104 without printing the received data and to print the received data using a password (print hold function for received data). If this function is set, the password must also be input for forwarding the received data. The print hold function for this received data is described below with reference to FIG. 14B.

In a FAX detail setting screen 1410, the print hold function for the received data described above is enabled by checking checkbox 1413 for the print hold of the received data and inputting the password 1414. As described above, when forwarding the received data with the print hold function for the received data enabled, the user must input the password corresponding to the password 1414 during the forwarding of received data. Just as printing is not performed without inputting the password, the received data is not forwarded without inputting the password. As described above, if the user sets the settings on the FAX setting screen 1400 and the FAX detail setting screen 1410, the setting values are stored in the HDD 104, and the like.

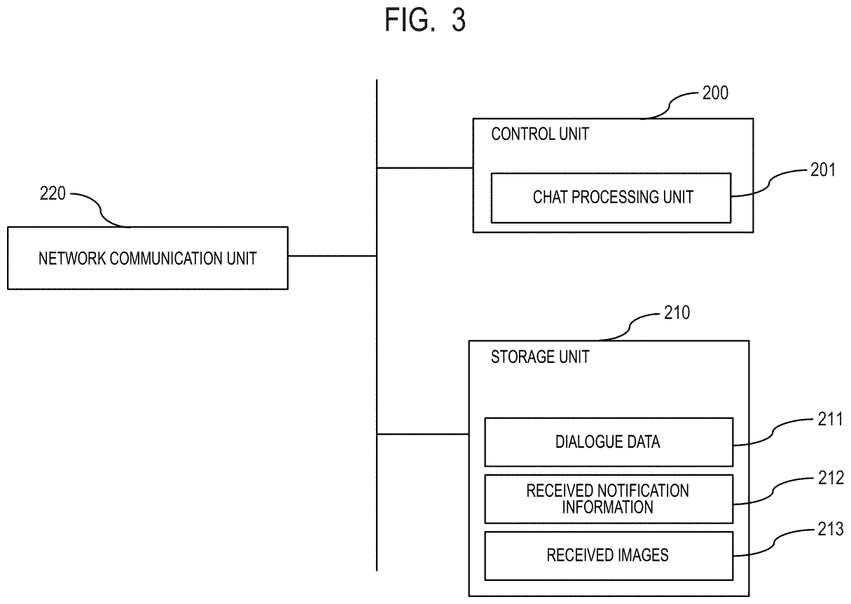

FIG. 3 illustrates a block diagram showing an example of the configuration of the chat server 20. The chat server 20 includes a control unit 200, a storage unit 210, and a network communication unit 220. The chat server 20 provides a message communication service (hereinafter referred to as a “chat service”) to the terminal device 30.

The control unit 200 includes a chat processing unit 201. The chat processing unit 201 analyzes a chat text (a message posted for the chat service) received from the terminal device 30, acquires an appropriate chat text from dialogue data 211, and responds to the terminal device 30. The chat processing unit 201 is realized by, for example, the control unit 200 reading and executing programs stored in the storage apparatus such as the storage unit 210.

The network communication unit 220 receives various messages such as FAX received notification information (a message indicating that a FAX has been received) from the image forming apparatus 10 via the internet 40.

The storage unit 210 stores the dialogue data 211, received notification information 212, and received images 213. The dialogue data 211 is dialogue data for performing chat processing and stores chat text necessary for the dialogue processing including chat text learned by the AI. The received notification information 212 stores notification information of the FAX data received from the image forming apparatus 10. The received images 213 store the images received from the image forming apparatus 10.

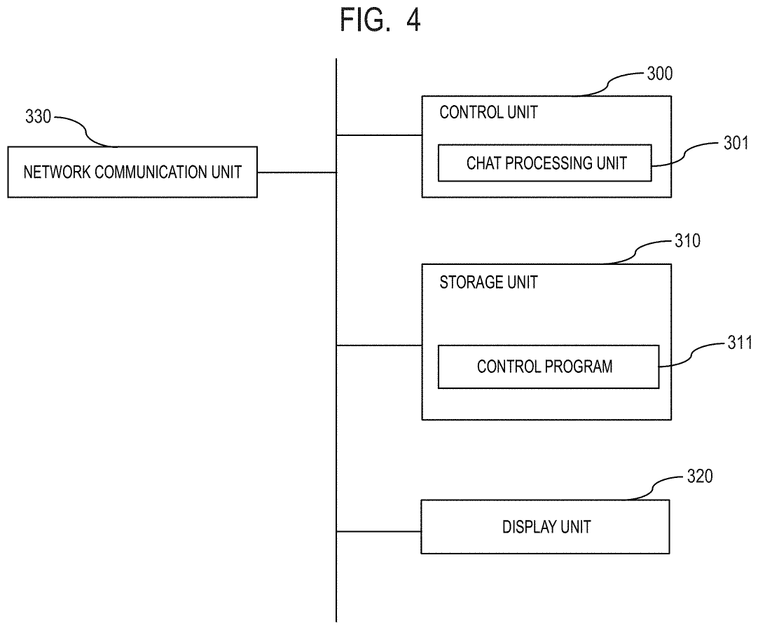

FIG. 4 illustrates a block diagram showing an example of the configuration of the terminal device 30. The terminal device 30 is an information processing device such as a smartphone, PC (personal computer), tablet, and the like. The terminal device 30 includes a control unit 300, a storage unit 310, a display unit 320, and a network communication unit 330.

The control unit 300 realizes various processes by reading and executing a control program 311 stored in the storage unit 310. The control program 311 also includes an interactive application (a chat processing unit 301) for interacting with the chat server 20. That is, the chat processing unit 301 is realized when the control unit 300 reads and executes the control program 311 stored in the storage unit 310.

The display unit 320 includes, for example, a display with a touch panel, and displays status of the terminal device 30 and receives operation. The display unit 320 displays the chat application screen of the interactive application, displays the chat text on the chat application screen, and receives the chat text input from the user. The network communication unit 330 is connected to the image forming apparatus 10 via the internet 40 and receives FAX received notification information from the image forming apparatus 10.

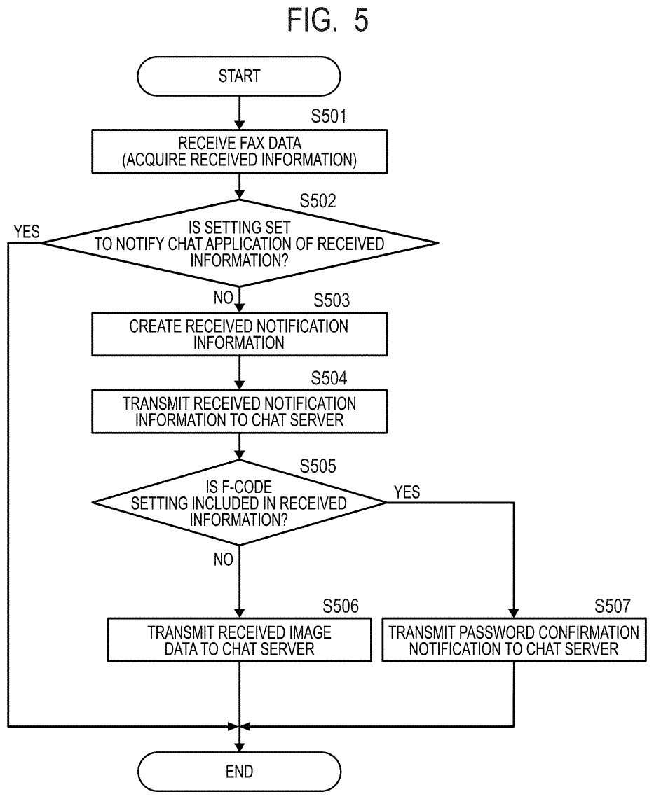

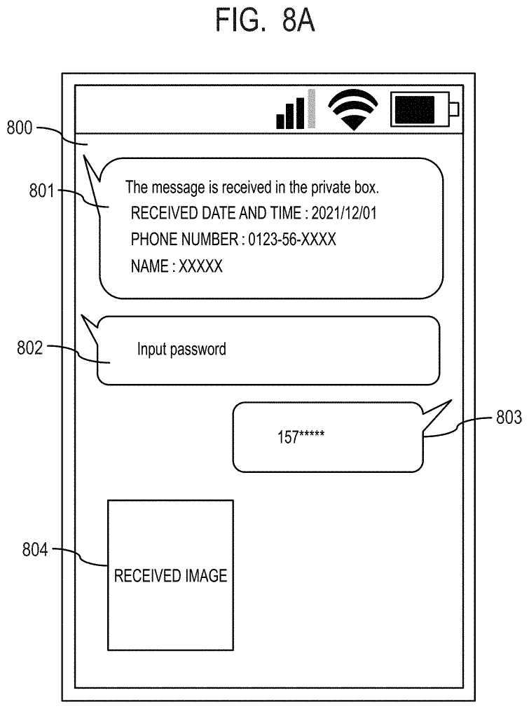

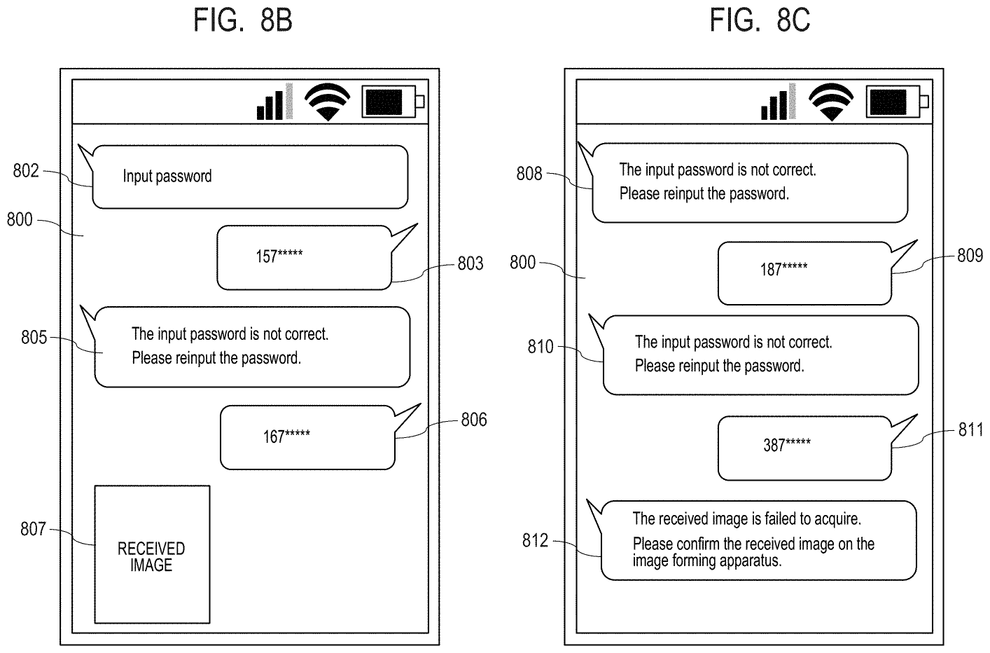

The operation of the image forming apparatus 10 is described below. FIG. 5 illustrates a flowchart showing an example of processing in which, when the image forming apparatus 10 receives the data from the FAX apparatus 50, the image forming apparatus 10 notifies the terminal device 30 of the received information and password confirmation via the chat server 20. The processing by the CPU 101 in the flowchart is realized when the CPU 101 reads and executes control programs stored in the ROM 102 or the like. FIGS. 8A to 8C illustrate an example showing the chat application screen 800 in the display unit 320 of the terminal device 30. Hereafter, FIGS. 8A to 8C are collectively referred to as “FIG. 8”.

In step S501, when the CPU 101 receives the data from the FAX apparatus 50 in the FAX control unit 112 via the PSTN, the CPU 101 acquires the received information and the received data to store the acquired received information and the received data in an HDD 104 or the like. As described above, when receiving the data from the FAX, if the F-code notified by the FAX apparatus 50 on the transmitting side matches the F-code registered in the private box of the image forming apparatus 10, the received data is stored in the private box. To view the received data stored in the private box, it is necessary to input the preset password (for example, the password set on the password 1513 in FIG. 15B) in the private box.

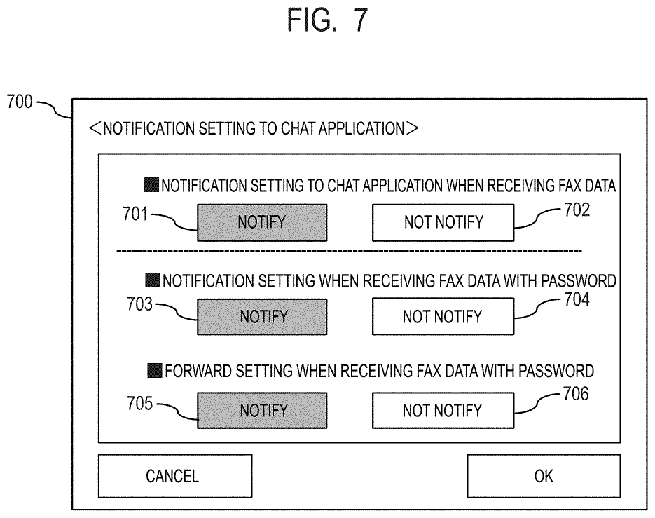

Then, in step S502, the CPU 101 determines whether or not a notification setting when the FAX data is received is set to notify the chat application shown in FIG. 7 later. If the notification setting is not set to notify received information notification (No in step S502), the CPU 101 terminates the processing of the flowchart.

On the other hand, if the notification setting is set to notify received information notification (Yes in step S502), the CPU 101 advances the process to step S503.

In step S503, the CPU 101 creates the received notification information for notifying the chat server 20 based on the received information stored in the HDD 104. Then, in step S504, the CPU 101 instructs the information notification control unit 113 to transmit the received notification information created in step S503 from the network control unit 108 to the chat server 20 via the LAN 120. As a result, the message of the received notification information is notified to the terminal device 30 via the chat server 20, and is displayed on the chat application screen 800 as shown in a message 801 in FIG. 8A, which will be described later. Thus, it is possible to present to the user that the FAX data is received.

Next, in step S505, the CPU 101 determines whether or not there is the F-code setting based on the received information stored in the HDD 104 in step S501. If there is no F-code setting (No in step S505), the CPU 101 advances the processing to step S506. In step S506, the CPU 101 instructs the information notification control unit 113 to transmit the received data stored in the HDD 104 in step S501 from the network control unit 108 to the chat server 20 via the LAN 120 and terminates the processing of the flowchart.

On the other hand, if there is the F-code setting (Yes in step S505), the CPU 101 advances the processing to step S507. In step S507, the CPU 101 instructs the information notification control unit 113 to transmit the password confirmation notification from the network control unit 108 to the chat server 20 via the LAN 120. As a result, a message of the password confirmation notification is notified to the terminal device 30 via the chat server 20 and is displayed on the chat application screen 800 as in message 802 in FIG. 8A, which will be described later. This allows the user to be prompted to input the password. After the processing in step S507, the CPU 101 terminates the processing of this flowchart.

In step S505, a message requesting the input of a password is controlled to be posted to the chat service on the condition that the received data includes the F-code setting. However, the present embodiment does not limit the condition that the received data includes the F-code setting for posting a message requesting the input of a password to the chat service. The present embodiment may include any condition that requires the input of a password to process the received data from the FAX. For example, regardless of whether or not the FAX apparatus 50 has an F-code setting, the image forming apparatus 10 may post the message requesting the input of a password to the chat service in a case where the setting in the image forming apparatus 10 requires a password to view the received data.

The example described here is a case where the received data from the FAX is posted to the chat service as the processing of received data from the FAX. However, the present embodiment does not limit the processing of received data from the FAX to the example. The image forming apparatus 10 posts a message requesting the input of a password to the chat service. The image forming apparatus 10 may post a message requesting the input of authentication information other than the password (for example, biometric authentication such as fingerprint authentication) to the chat service.

According to the processing of FIG. 5, according to receiving the data from the FAX, a message of reception notification information such as 801 in FIG. 8A and a message of password confirmation such as 802 can be displayed on the chat application screen 800 of the terminal device 30 via the chat server 20. If these messages are prompted and the user inputs the password via the chat application screen 800 of the terminal device 30, for example as 803 in FIG. 8A, the input password is notified to the image forming apparatus 10 via the chat server 20. The processing if the image forming apparatus 10 receives the password entry notification from the chat server 20 is described below.

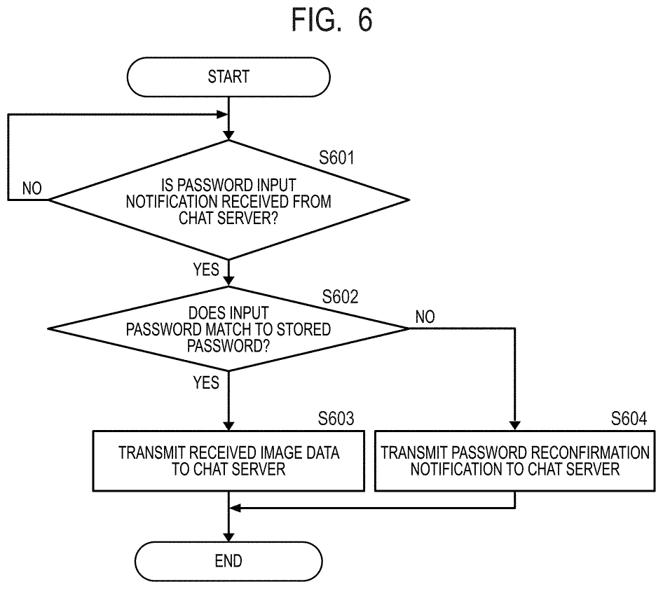

FIG. 6 illustrates a flowchart showing the processing when the user inputs the password via the terminal device 30 based on the password confirmation notification in step S507 of FIG. 5 and the image forming apparatus 10 receives the password input notification via the chat server 20. The processing by the CPU 101 in the flowchart is realized when the CPU 101 reads and executes a control program stored in the ROM 102 or the like.

In step S601, the CPU 101 determines if the password input notification is received by the information reception control unit 114, that is, whether or not there is a password input notification. If the password input notification is not received by the information reception control unit 114, that is, if there is no password input notification (No in step S601), the CPU 101 repeats the process in step S601. On the other hand, if the password input notification is received by the information reception control unit 114, that is, if there is a password input notification (Yes in step S601), the CPU 101 advances the process to step S602.

In step S602, the CPU 101 determines whether or not the password received in the above password input notification matches the preset password stored in the HDD 104 of the image forming apparatus 10. The preset password stored in the HDD 104 of the image forming apparatus 10 is the password corresponding to the private box in which the received data from the FAX is stored in step S501 of FIG. 5, and for example, the password set from the password 1513 in FIG. 15B and stored in the HDD 104 is shown.

If the password received in the above password input notification matches the preset password stored in the HDD 104 of the image forming apparatus 10 (Yes in step S602), the CPU 101 advances the process to step S603. In step S603, the CPU 101 instructs the information notification control unit 113 to transmit the received data stored in the HDD 104 or the like in step S501 of FIG. 5 from the network control unit 108 to the chat server 20 via the LAN 120. That is, a message indicating the content of the data received in step S501 of FIG. 5 is posted. As a result, the received data is notified to the terminal device 30 via the chat server 20, and the received data is displayed on the chat application screen 800 of the terminal device 30 as in message 804 of FIG. 8A.

On the other hand, if the password received in the above password input notification does not match the preset password stored in the HDD 104 of the image forming apparatus 10 (No in step S602), the CPU 101 advances the process to step S604. In step S604, the CPU 101 instructs the information notification control unit 113 to transmit a password reconfirmation notification from the network control unit 108 to the chat server 20 via the LAN 120. As a result, the password reconfirmation message is notified to the terminal device 30 via the chat server 20, and the password reconfirmation message is displayed on the chat application screen 800 of the terminal device 30 as shown in 805 in FIG. 8B. After the processing of step S603 or S604, the CPU 101 terminates the process of the flowchart.

Based on the above processing, according to the conditions (in the above example, the F-code is set in the received data from the FAX), a message requesting the input of authentication information (in the above example, the password) is posted on the chat service, and the input of authentication information via the chat service is received. That is, if the input of authentication information such as a password is required for the processing of the received data from the FAX (in the above example, viewing the received data), the authentication information is received via the chat service. Then, the processing of the received data can be controlled based on the authentication information. For example, if receiving data with an F-code setting from the FAX, a password can be input via the chat application to properly display the received data in the chat application. This reduces the risk of unauthorized viewing of the received data by a disinterested person, thus solving security issues and improving usability of the FAX function.

FIG. 7 illustrates an example showing the chat application notification setting screen for transmitting information notification to the chat application of the terminal device 30 when receiving the data from the FAX on the image forming apparatus 10. In a chat application notification setting screen 700, the notification setting to the chat application when receiving the data from the FAX is set whether or not the image forming apparatus 10 transmits the receiving information notification to the chat application of the terminal device 30 when the image forming apparatus receives the data from the FAX. If the notification setting is set to a “notify” 701, the image forming apparatus 10 transmits the receiving information notification to the chat application of the terminal device 30 when receiving the data from the FAX. If the notification setting is set to a “not notify” 702, the image forming apparatus 10 does not transmit the receiving information notification to the chat application of the terminal device 30 when receiving the data from the FAX.

In the notification setting for receiving the data from the FAX with a password, the notification setting to the chat application when receiving the data from the FAX with the password is set whether or not the image forming apparatus 10 transmits the receiving information notification to the chat application of the terminal device 30 when the image forming apparatus 10 receives the data from the FAX that requires inputting the password when viewing the received data. If the notification setting is set to a “notify” 703, the image forming apparatus 10 transmits the receiving information notification and password confirmation notification to the chat application when the image forming apparatus 10 receives the data from the FAX that requires inputting the password when viewing the received data from the FAX. If the notification setting is set to a “not notify” 704, the image forming apparatus 10 does not transmit the receiving information notification to the chat application of the terminal device 30 when the image forming apparatus 10 receives the data from the FAX that requires inputting the password when viewing the received data from the FAX.

In step S501 shown in FIG. 5, if receiving the data from the FAX without the F-code setting, the image forming apparatus 10 determines that the data from the FAX that does not require inputting the password when viewing the data from the FAX is received. Then, the determination is Yes in step S502 in response to setting the notification setting to the “notify” 701. On the other hand, the determination is No in step S502 in response to setting the notification setting to the “not notify” 702. In addition, when the data with F-code setting is received from the FAX, the image forming apparatus 10 determines that the data from the FAX that requires inputting the password is received to view the received data. Then, in response to setting the notification setting to the “notify” 701 and “notify” 703, the determination is Yes in step S505. On the other hand, in response to setting the notification setting to the “not notify” 702 and the “not notify” 704, the determination is No in step S505. That is, the notification setting (703,704) when receiving the data from the FAX with the password corresponds to the setting as to whether or not the user inputs the password required for posting the received data via the chat service.

In the forwarding setting of the data from the FAX with the password, if the image forming apparatus 10 receives the data from the FAX that requires the password to be input at the time of forwarding, the setting is made as to whether or not the user inputs the password in the chat application to issue the forwarding instruction. If the forwarding setting is set to a “forward” 705, the image forming apparatus 10 transmits the password confirmation notification to the chat application when the data from the FAX that requires inputting the password at the time of forwarding the data is received. If the forwarding setting is set to a “not forward” 706, the image forming apparatus 10 does not transmit the password confirmation notification to the chat application when the data from the FAX that requires inputting the password at the time of forwarding the data is received. That is, the forwarding setting (705,706) of the data from the FAX with the password corresponds to the setting whether or not the user inputs the password required for the forwarding process via the chat service.

Note that the “notification setting when receiving FAX with password” and “forwarding setting when receiving FAX with password” are effective only if the “notify” 701 is set in “notification setting to chat application when receiving”. If the “not notify” 702 is set, the settings of 703 to 706 are not effective and the settings are disabled.

As described above, if the settings of 701 to 706 are made in the chat application notification setting screen 700 and the user presses the “OK” button, these settings are stored in the HDD 104 or the like of the image forming apparatus 10.

A chat application screen 800 when the image forming apparatus 10 notifies the terminal device 30 of the received information and password confirmation at the time of receiving the data from the FAX is described below with reference to FIG. 8. In the chat application notification setting screen 700 of FIG. 7, it is assumed that the forwarding setting for the data from the FAX with password is set to “notify” 701 and the notification setting for FAX with password reception is set to “notify” 703.

FIG. 8A illustrates an example showing the chat application screen when the image forming apparatus 10 receives the data from the FAX with F-code, displays the received information and password confirmation on the chat application screen 800, and the user's password input matches the preset password. A message 801 indicates the received date and time, the telephone number, and the transmitter's name as the received notification information.

Subsequently, a message 802 indicates a password confirmation message. In a message 803, the user inputs the password. The image forming apparatus 10 performs the password confirmation on the password input in the message 803, and if the input password matches the preset password, the received data of the message 804 is displayed.

FIG. 8B illustrates an example showing the chat application screen if the image forming apparatus 10 receives the data from the FAX with the F-code, displays the received information and the password confirmation on the chat application screen 800, and the password does not match the preset password. Note that the same message as in FIG. 8A is given the same reference number, and the description is omitted.

The image forming apparatus 10 performs the password confirmation on the password input in the message 803, and if the password does not match the preset password, a message to reconfirm the password in the message 805 is displayed. In the message 806, the user re-inputs the password. The image forming apparatus 10 confirm the password input in the message 806, and if the password matches the preset password, the received data (the received image) of the message 807 is displayed.

FIG. 8C illustrates an example showing the chat application screen if the image forming apparatus 10 receives the data from the FAX with the F-code, displays the received information and the password confirmation on the chat application screen 800, and the password confirmation fails more than a predetermined number of times.

The message 808 indicates the password reconfirmation message. In the message 809, the user re-inputs the password. The image forming apparatus 10 performs the password confirmation with the password input in the message 810, and if the password does not match the preset password, the message of reconfirming the password in the message 811 is displayed. In the message 812, if the password does not match the preset password in the password confirmation more than a predetermined number of times, acquisition of the received data (the received image) fails and a message prompting confirmation in the image forming apparatus 10 is displayed.

The predetermined number of times is determined in the image forming apparatus 10, and the predetermined number of times may be set by the user. This prevents viewing illegally the received data by a disinterested person who does not know the password.

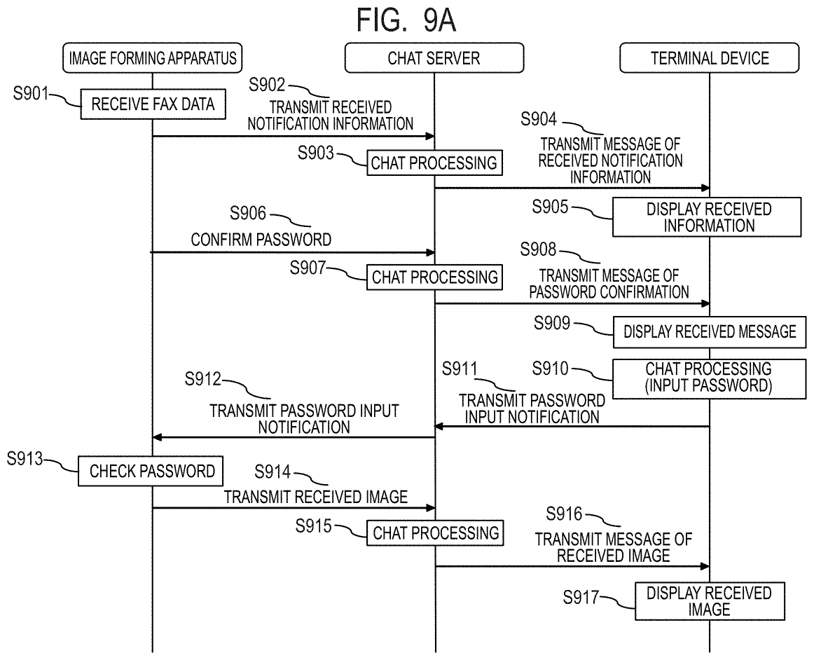

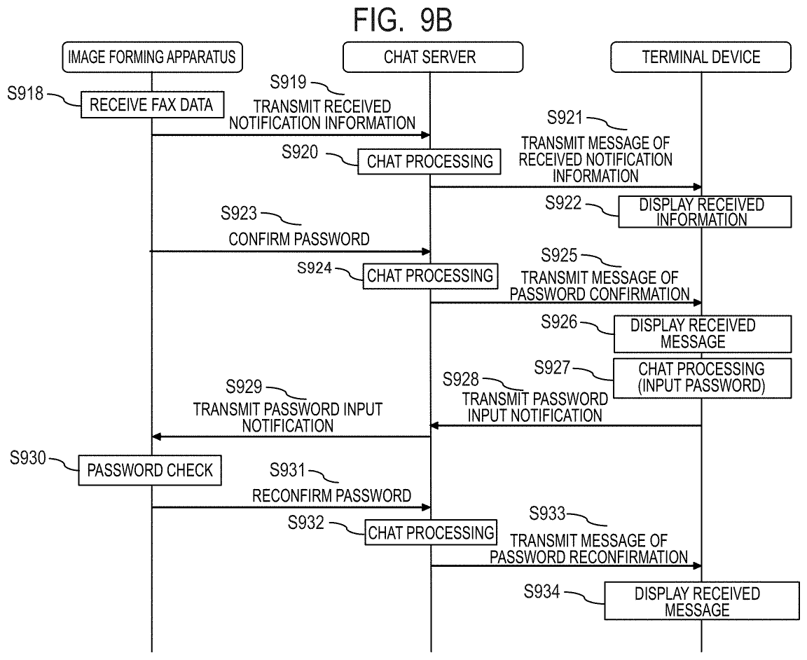

FIGS. 9A and 9B illustrate the sequence in which the image forming apparatus 10 notifies the terminal device 30 of the received information at a time of receiving the data from the FAX. Note that in the chat application notification setting screen 700 of FIG. 7, the forwarding setting for FAX with password is set to “notify” 701, and the notification setting for FAX with password reception is set to “notify” 703.

FIG. 9A illustrates a diagram showing the sequence when the image forming apparatus 10 receives the data from the FAX with the F-code, displays the received information and password confirmation on the chat application screen 800, and the user's password matches the preset password. FIG. 9A is described as displaying the chat application screen 800 of FIG. 8A.

In step S901, the image forming apparatus 10 receives the data from the FAX apparatus 50. At that time, the image forming apparatus 10 acquires the received information of the received data and the received data (the received image) and stores the received information and the received data (the received image) in the HDD 104. Then, in step S902, the image forming apparatus 10 creates the received notification information on the basis of the received information stored in the HDD 104 in step S901 and transmits the received notification information to the chat server 20.

In step S903, the chat server 20 stores the received notification information received from the image forming apparatus 10 in the received notification information 212 of the storage unit 210. In addition, the chat processing unit 201 of the control unit 200 analyzes the received notification information stored in the received notification information 212 and creates the chat message about the reception information from the dialogue data 211. In step S904, the chat server 20 transmits the chat message about the received information created in step S903 to the terminal device 30.

In step S905, the terminal device 30 receives the message about the received notification information from the chat server 20 in the chat processing unit 301 of the control unit 300. The control program 311 of the storage unit 310 also starts the chat application and displays the chat message (the message about the above received notification information) received from the chat server 20 on the display unit 320 as the message 801 in FIG. 8A.

In step S906, the image forming apparatus 10 determines whether or not there is the F-code setting based on the received information stored in the HDD 104. If there is a code setting, the image forming apparatus 10 transmits the password confirmation to the chat server 20. In step S907, the chat server 20 analyzes the password confirmation received from the image forming apparatus 10 in the chat processing unit 201 of the control unit 200, and creates a chat message about the password confirmation from the dialogue data 211. In step S908, the chat server 20 transmits the chat message about the password confirmation created in step S907 to the terminal device 30.

In step S909, the terminal device 30 receives the password confirmation message from the chat server 20 in the chat processing unit 301 of the control unit 300. The control program 311 of the storage unit 310 also starts the chat application and displays the chat message (the above password confirmation message) received from the chat server 20 on the display unit 320 as the message 802 in FIG. 8A.

In step S910, the terminal device 30 receives the user's password input from the display unit 320 as the message 803 in FIG. 8A. The contents of the password input are analyzed in the chat processing unit 301 of the control unit 300 to create the password input notification. In step S911, the terminal device 30 transmits the password input notification created in step S910 to the chat server 20.

In step S912, the chat server 20 analyzes the password input notification received from the terminal device 30 in the chat processing unit 201 of the control unit 200 and transmits the password input notification to the image forming apparatus 10. In step S913, the image forming apparatus 10 analyzes the password input notification received from the chat server 20 in the CPU 101 and determines whether or not the password matches the preset password. FIG. 9A describes the case where the password matches the preset password. In step S914, since the image forming apparatus 10 determines that the password matches the preset password in step S913 above, the image forming apparatus 10 acquires the received data (the received image) from the HDD 104 and transmits the received data (the received image) to the chat server 20.

In step S915, the chat server 20 stores the received data (the received image) received from the image forming apparatus 10 in the received images 213 of the storage unit 210. The chat processing unit of the control unit 200 analyzes the received data (the received image) stored in the received images 213 and creates the chat message. In step S916, the chat server 20 transmits the chat message about the received data (the received image) created in step S915 to the terminal device 30.

In step S917, the terminal device 30 receives the message about the received data (the received image) from the chat server 20 in the chat processing unit 301 of the control unit 300. The control program 311 of the storage unit 310 also starts the chat application and displays the chat message (the message about the received data (the received image)) received from the chat server 20 on the display unit 320 as the message 804 in FIG. 8A.

FIG. 9B illustrates a diagram showing the sequence when the image forming apparatus 10 receives the data from the FAX with the F-code, displays the received information and password confirmation on the chat application screen 800, and the password does not match the preset password. In FIG. 9B, the sequence is described as displayed on the chat application screen 800 of FIG. 8B and FIG. 8C. Since steps S918 to S929 in FIG. 9B have the same processing as steps S901 to S912 in FIG. 9A, the description is omitted.

In step S930, the image forming apparatus 10 analyzes the password input notification received from the chat server 20 by the CPU 101 and determines whether or not the password matches the preset password. FIG. 9B describes the case where the password does not match the preset password. In step S931, since the password does not match the preset password, the image forming apparatus 10 again transmits the password confirmation message (password reconfirmation message) to the chat server 20.

In step S932, the chat server 20 analyzes the password reconfirmation received from the image forming apparatus 10 in the chat processing unit 201 of the control unit 200, and creates the chat message about the password reconfirmation from the dialogue data 211. In step S933, the chat server 20 transmits the chat message about the password reconfirmation created in step S932 to the terminal device 30.

In step S934, the terminal device 30 receives the password reconfirmation message from the chat server 20 in the chat processing unit 301 of the control unit 300. The control program 311 of the storage unit 310 also starts the chat application and displays the chat message (the above password reconfirmation message) received from the chat server 20 on the display unit 320 as the message 805 of FIG. 8B.

Thereafter, although not shown in FIG. 9B, the processing of steps S927 to S930 (the same processing as steps S910 to S913) is repeated. Then, if the password matches the preset password, the processing of steps S914 to S917 of FIG. 9A is performed, and the received image of the message 807 of FIG. 8B is displayed on the chat application screen 800 of the terminal device 30.

Further, although not shown in FIG. 9B, the processing of steps S927 to S930 (same processing as steps S910 to S913) is repeated, the password confirmation is performed, and the case where the password does not match the preset password the predetermined number of times is described. In this case, the image forming apparatus 10 transmits the message to the chat server 20 indicating that acquisition of the received image has failed. This message is transmitted to the terminal device 30 via the chat server 20, and the chat application screen 800 of the terminal device 30 displays that acquisition of the received image of the message 812 in FIG. 8C has failed.

As described above, in the first embodiment, if the image forming apparatus 10 receives the data from the FAX with the F-code setting, password confirmation is performed on the terminal device 30, and the received image is displayed on the chat application of the terminal device 30 only when the password matches the preset password. This makes it possible to display an appropriate received image from the FAX based on the password input. Thus, the risk of viewing the received image by a disinterested person can be reduced and security issues can be solved.

In the above embodiment, if the image forming apparatus 10 receives the data from the FAX with the F-code setting, the image forming apparatus 10 confirms the password on the terminal device 30 via the chat service and prompts the user to input the password. Note that if the setting of “not notify” 704 is set, the above password confirmation is not performed. However, even if the password confirmation is not performed, the user may actively post the password (“12345” in the above example) in the message such as “password: 12345” from the chat service. When the image forming apparatus 10 receives the password, the image forming apparatus 10 may process the received data from the FAX (post the received image to the chat service) if the password matches the preset password.

It may also enable the user to actively instruct the chat service to process the data from the FAX (for example, printing, transferring, and the like) after the password matches the preset password, and the image forming apparatus 10 receiving the instruction may perform the processing on the received data from the FAX in response to the instruction.

### Second Embodiment

In the second embodiment, when the image forming apparatus 10 receives the data from the FAX apparatus 50 that requires inputting the password during forwarding, a configuration will be described in which the received information is notified to the chat application of the terminal device 30, the password is confirmed, and if the password matches the preset password, the received data from the FAX is forwarded. Note that the password input is required when forwarding the data received from the FAX when the image forming apparatus 10 receives data from the FAX and the received data meets the forward conditions set in the image forming apparatus 10, and the print hold function is enabled in the image forming apparatus 10.

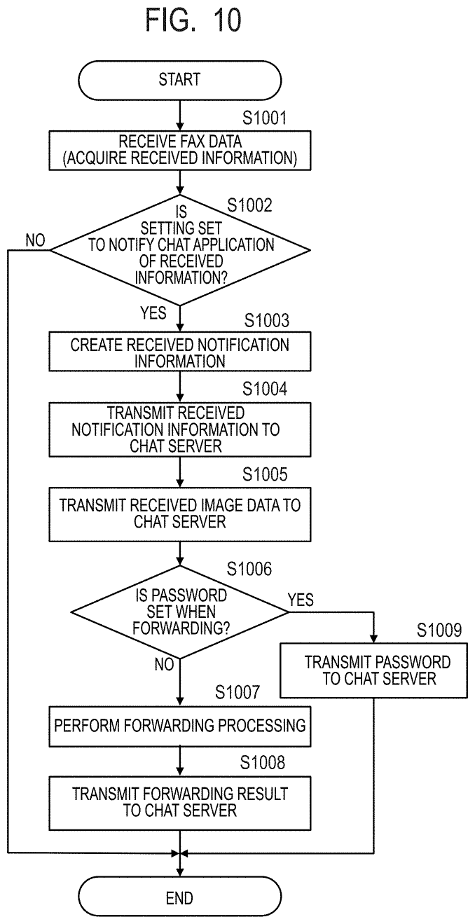

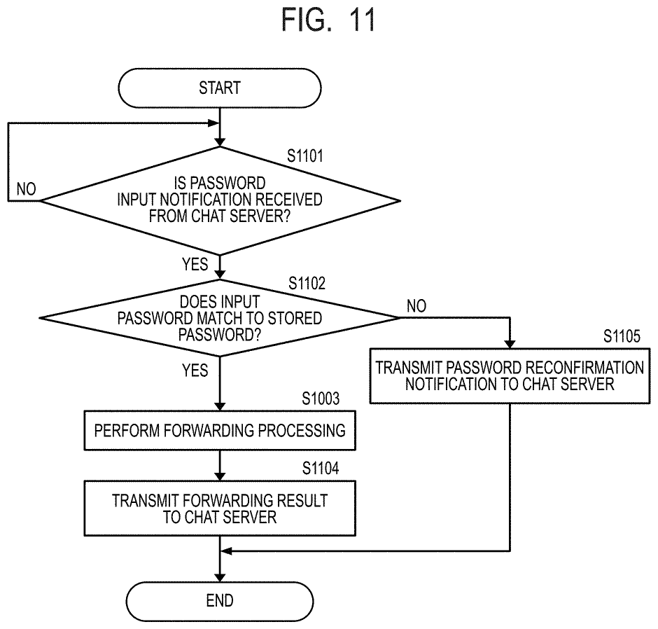

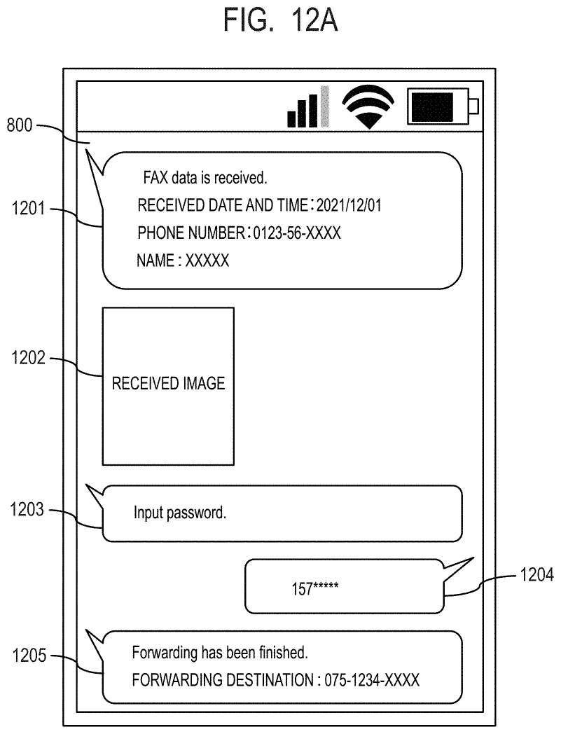

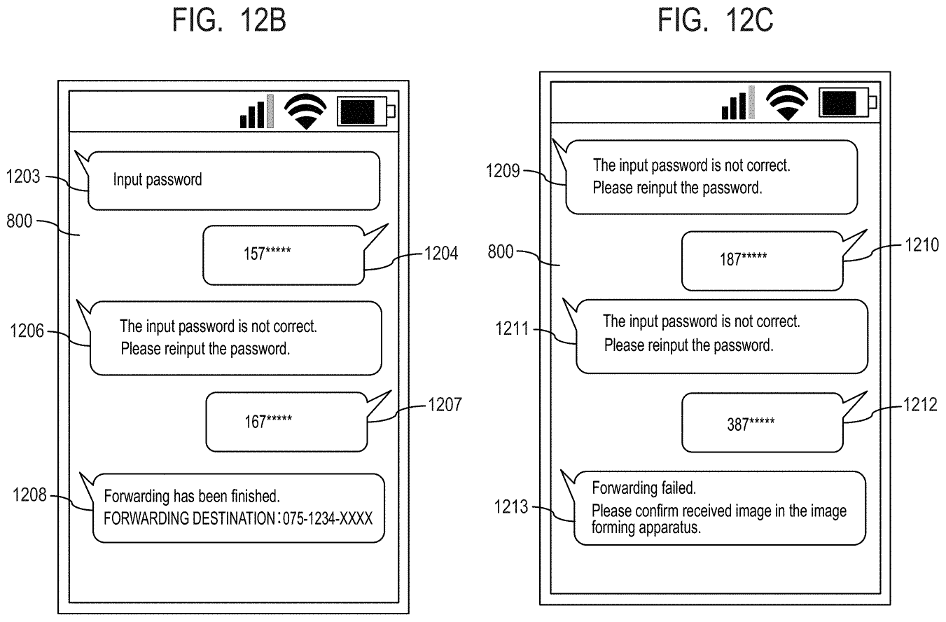

FIG. 10 illustrates a flowchart showing an example of processing in which the image forming apparatus 10 receives the data from the FAX apparatus 50 that requires inputting the password during forwarding, the image forming apparatus 10 transmits the received notification and the password confirmation notification to the terminal device 30 via the chat server 20. The processing by the CPU 101 in the flowchart is realized by the CPU 101 reading and executing a control program stored in the ROM 102 or the like. FIGS. 12A to 12C illustrate an example showing the chat application screen 800 displayed on the display unit 320 of the terminal device 30. Hereafter, FIGS. 12A to 12C are collectively referred to as “FIG. 12”.

In step S1001, if the CPU 101 receives the data from the FAX apparatus 50 via the PSTN in the FAX control unit 112 and meets the preset forwarding conditions, the CPU 101 acquires the received information and the received data (the received image), and stores the acquired received information and the received data (the received image) in the HDD 104 or the like.

Then, in step S1002, the CPU 101 determines whether or not the received information notification setting for the chat application shown in FIG. 7 is the setting for notifying the chat application. If the received information notification setting is not the setting for notifying the received information notification (No in step S1002), the CPU 101 terminates the processing of the flowchart.

On the other hand, if the received information notification setting is the setting for notifying the received information notification (Yes in step S1002), the CPU 101 advances the process to step S1003.

In step S1003, the CPU 101 creates the received notification information for notifying the chat server 20 based on the received information stored in the HDD 104 in step S1001. Then, in step S1004, the CPU 101 instructs the information notification control unit 113 to transmit the received notification information created in step S1003 from the network control unit 108 to the chat server 20 via the LAN 120. As a result, the message of the received notification information is notified to the terminal device 30 via the chat server 20, and is displayed on the chat application screen 800 as shown in message 1201 in FIG. 12A, which will be described later. In this way, it is possible to present to the user that the data has been received from the FAX.

Then, in step S1005, the CPU 101 instructs the information notification control unit 113 to transmit the received data stored in the HDD 104 in step S1001 from the network control unit 108 to the chat server 20 via the LAN 120. As a result, the received data is notified to the terminal device 30 via the chat server 20, and the received data is displayed on the chat application screen 800 of the terminal device 30 as shown in message 1202 in FIG. 12A.

Then, in step S1006, the CPU 101 determines whether or not the password is set for the forwarding function. The password setting for the forwarding function is determined based on whether or not the print hold function for received data described above is enabled in the image forming apparatus 10. The above enable/disable setting of the print hold function of received data is preset in screens such as the FAX detail setting screen 1410 of the image forming apparatus 10 illustrated in FIG. 14B, and the setting value is stored in the HDD 104. In step S1006, the above setting value is acquired from the HDD 104 to determine whether or not the password is set. In the example of the FAX detail setting screen 1410 in FIG. 14B, in the case of the setting in which the print holding 1413 of the received data is confirmed and the password 1414 is registered, the print hold function of the received data described above is enabled. In the case of other settings, the print hold function of the received data described above is disabled.

If the setting is such that password confirmation is not performed at the time of forwarding (No in step S1006), the CPU 101 advances the process to step S1007. In step S1007, the CPU 101 instructs the FAX control unit 112 to execute the FAX forwarding processing. In step S1008, the CPU 101 instructs the information notification control unit 113 to transmit the result of the FAX forwarding processing executed in step S1007 to the chat server 20, and terminates the processing of the flowchart.

On the other hand, in the case of setting to confirm the password upon forwarding (Yes in step S1006), the CPU 101 advances the process to step S1009. In step S1009, the CPU 101 instructs the information notification control unit 113 to transmit the password confirmation notification from the network control unit 108 to the chat server 20 via the LAN 120. As a result, the message of the password confirmation notification is notified to the terminal device 30 via the chat server 20, and is displayed on the chat application screen 800 as shown in message 1203 in FIG. 12A, which will be described later. This allows the user to be prompted to input the password. After the processing in step S1009, the CPU 101 terminates the processing of the flowchart.

According to the processing in FIG. 10, according to receiving the data from the FAX, the received notification information like a message 1201 in FIG. 12A, the received image like 1202, and the password confirmation message like a message 1203 can be displayed on the chat application screen 800 of the terminal device 30 via the chat server 20. If the user is prompted by these messages to input the password from the chat application screen 800 of the terminal device 30, for example like 1204 in FIG. 12A, the input password is notified to the image forming apparatus 10 via the chat server 20. The processing when the image forming apparatus 10 receives the password input notification from the chat server 20 is described below.

FIG. 11 illustrates a flowchart showing the processing if the password is input by the terminal device 30 based on the password confirmation notification in step S1009 of FIG. 10 and the password input notification is received by the image forming apparatus 10 via the chat server 20. The processing by the CPU 101 in the flowchart is realized when the CPU 101 reads and executes a control program stored in the ROM 102 or the like.

In step S1101, the CPU 101 determines whether or not there is a password input notification from the chat server 20 via the information reception control unit 114. If the information reception control unit 114 does not receive the password input notification, that is, if there is no password input notification (No in step S1101), the CPU 101 repeats the process in step S1101. On the other hand, if the information reception control unit 114 receives the password input notification, that is, if there is a password input notification (Yes in step S1101), the CPU 101 advances the process to step S1102.

In step S1102, the CPU 101 determines whether or not the password received in the above password input notification matches the preset password stored in the HDD 104 of the image forming apparatus 10. The preset password stored in the HDD 104 of the image forming apparatus 10 indicates the password that is set from the password 1414 and stored in the HDD 104 in the example of the FAX detail setting screen 1410 in FIG. 14B.

If the password received in the above password input notification matches the preset password stored in the HDD 104 of the image forming apparatus 10 (Yes in step S1102), the CPU 101 advances the process to step S1103. In step S1103, the CPU 101 instructs the FAX control unit 112 to execute FAX data forwarding processing. Then, in step S1104, the CPU 101 instructs the information notification control unit 113 to transmit the result of the FAX data forwarding processing executed in step S1103 to the chat server 20, and terminates the processing of the flowchart.

On the other hand, if the password received in the above password input notification does not match the preset password stored in the HDD 104 of the image forming apparatus 10 (No in step S1102), the CPU 101 advances the process to step S1105. Here, it is assumed that the forwarding setting for the received data with passwords is set to “forward” 705 in the chat application notification setting screen 700 in FIG. 7.

In step S1105, the CPU 101 instructs the information notification control unit 113 to transmit the password reconfirmation notification from the network control unit 108 to the chat server 20 via the LAN 120. As a result, the password reconfirmation message is notified to the terminal device 30 via the chat server 20, and the password reconfirmation message is displayed on the chat application screen 800 of the terminal device 30 as shown in 1206 in FIG. 12B. After the processing in step S1105, the CPU 101 terminates the processing of the flowchart.

According to the above processing, if it is necessary to input authentication information such as a password for processing received data from the FAX (forwarding processing in the above example), the authentication information can be received via the chat application, and the processing of received data can be controlled based on the authentication information. For example, if receiving the data from the FAX that requires the input of the password for forwarding the received data, the password can be input via the chat application to properly forward the received data. Therefore, the security issues can be solved and usability related to the FAX function can be improved by allowing proper forward processing to be performed by the input of the password to reduce the risk of the received data from the FAX being forwarded without permission.

The chat application screen 800 when the image forming apparatus 10 notifies the terminal device 30 of the received information and the password confirmation upon receiving the data from the FAX that meets the forwarding conditions is described below with reference to FIG. 12. Here, it is assumed that the forwarding setting for the received data from the FAX with the password is set to “notify” 701 and the forwarding setting for the received data from the FAX with the password is set to “forward” 705 in the chat application notification setting screen 700 in FIG. 7.

FIG. 12A illustrates an example showing the chat application screen when the image forming apparatus 10 receives the data from the FAX that requires inputting the password during forwarding, displays the received information and password confirmation on the chat application screen 800, and the password input by the user matches the preset password.

The message 1201 displays the received date and time, the telephone number, and the transmitter's name as the received notification information. The message 1202 displays the received data (the received image). Subsequently, the message 1203 displays the password confirmation message.

In the message 1204, the user inputs the password. The image forming apparatus 10 performs the password confirmation with the password input in the message 1204. If the password matches the preset password, the image forming apparatus 10 executes the forwarding process and displays the completion of the forwarding and information of the forwarding destination as the forwarding result message 1205.

FIG. 12B illustrates an example showing the chat application screen when the image forming apparatus 10 receives the data from the FAX that requires inputting the password during forwarding, displays the received information and password confirmation on the chat application screen 800, and the password input by the user does not match the preset password. The same message as in FIG. 12A is denoted by the same symbol, and the description is omitted.

The image forming apparatus 10 performs the password confirmation on the password input in the message 1204. If the password does not match the preset password, the message to reconfirm the password in the message 1206 is displayed. In the message 1207, the user re-inputs the password. The image forming apparatus 10 performs the password confirmation with the password input in the message 1207. If the password matches the preset password, the image forming apparatus 10 performs the forwarding process and displays the completion of the forwarding and information of the forwarding destination as the message 1208.

FIG. 12C illustrates an example showing the chat application screen when the image forming apparatus 10 receives the data from the FAX that requires inputting the password during forwarding, displays the received information and password confirmation on the chat application screen 800, and the password input by the user does not match the preset password more than a predetermined number of times.

The message 1209 displays the password reconfirmation message. In the message 1210, the user re-inputs the password. The image forming apparatus 10 performs the password confirmation with the password input in the message 1210. If the password does not match the preset password, the message of re-confirming the password in the message 1211 is displayed. In the message 1213, if the password input by the user in the message 1212 does not match the preset password in the password confirmation more than a predetermined number of times, the forwarding data from FAX fails and the message prompting confirmation in the image forming apparatus 10 is displayed.

The predetermined number of times is determined by the image forming apparatus 10, and the predetermined number of times may be set by the user. This scheme can prevent forwarding the received data from the FAX illegally by a disinterested person who does not know the password.

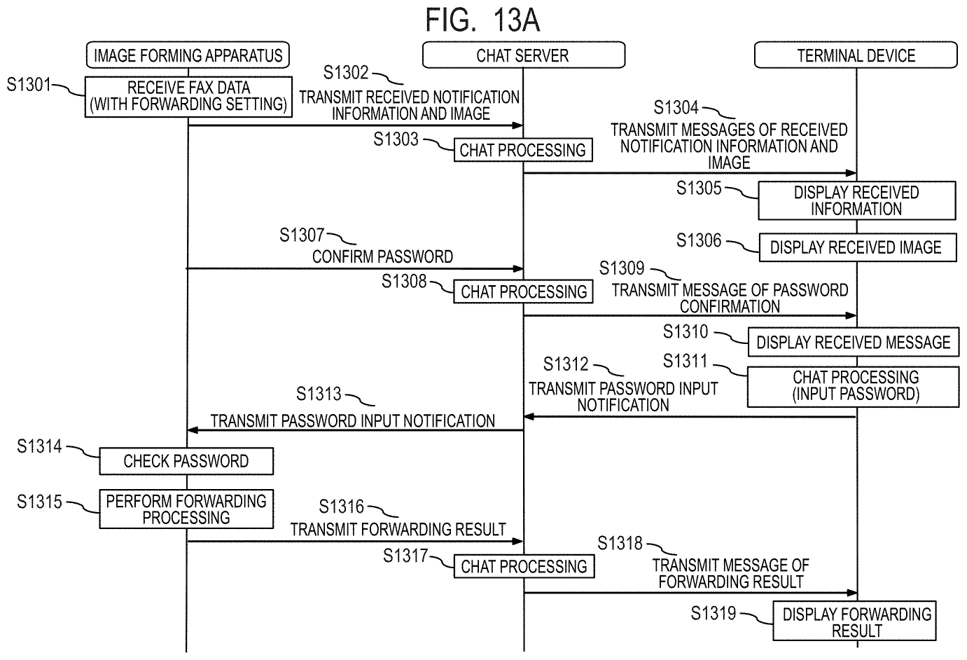

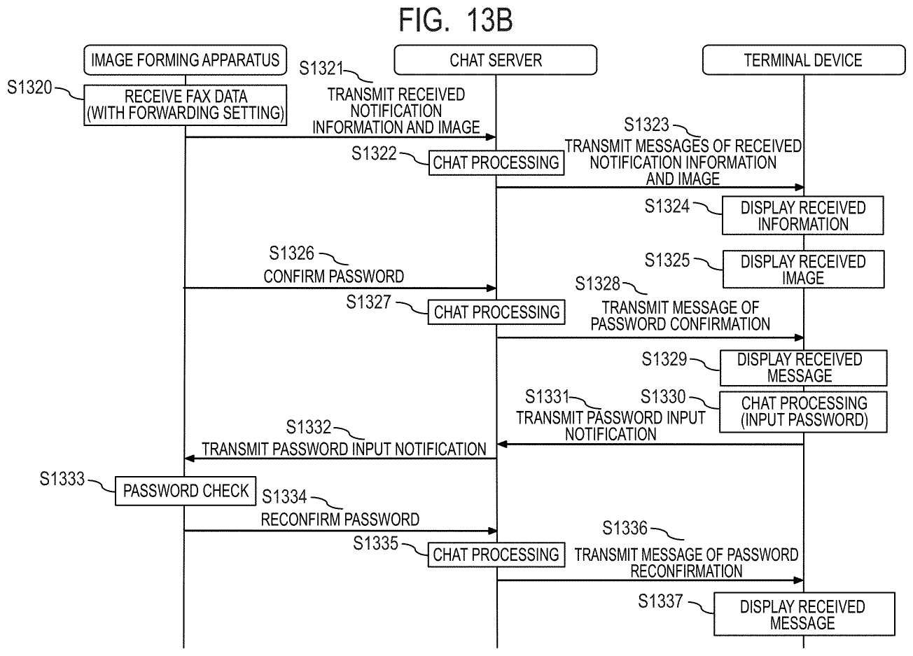

FIGS. 13A and 13B illustrate the sequence in which the image forming apparatus 10 notifies the terminal device 30 of the received information upon receiving the data from the FAX that meets the forwarding conditions and requires inputting the password upon forwarding. Here, it is assumed that the notification setting for the data from the FAX with password is set to “notify” 701, and the forwarding setting for the data from the FAX with password is set to “forward” 705 in the chat application notification setting screen 700 in FIG. 7.

FIG. 13A illustrates a diagram showing the sequence when the image forming apparatus 10 receives the data from the FAX that meets the forwarding conditions and requires inputting the password upon forwarding, displays the received information and password confirmation on the chat application screen 800, and the password input by the user matches the preset password. In the description of FIG. 13A, the chat application screen 800 of FIG. 12A is described as being displayed.

In step S1301, the image forming apparatus 10 receives the data matching the forwarding settings from the FAX apparatus 50. At that time, the image forming apparatus 10 acquires the received information of the received data from the FAX and the received image and stores them in the HDD 104. Then, in step S1302, the received notification information is created based on the received information stored in the HDD 104, and the received notification information and the received data (the received image) are transmitted to the chat server 20.

In step S1303, the chat server 20 stores the received notification information and the received image received from the image forming apparatus 10 in the received notification information 212 of the storage unit 210. Further, the chat processing unit 201 of the control unit 200 analyzes the received notification information and the received image stored in the received notification information 212 and creates the chat message about the received notification information and the received image based on the dialogue data 211. In step S1304, the chat server 20 transmits the received notification information and the chat message about the received image created in step S1303 to the terminal device 30.

In step S1305, the terminal device 30 receives the received notification information and the message about the received image from the chat server 20 in the chat processing unit 301 of the control unit 300. The control program 311 of the storage unit 310 also starts the chat application and displays the chat message (the message of the received notification information described above) received from the chat server 20 on the display unit 320 as the message 1201 in FIG. 12A.

In step S1306, the control program 311 of the storage unit 310 starts the chat application and displays the chat message (the message of the received image described above) received from the chat server 20 on the display unit 320 as the message 1202 in FIG. 12A.

In step S1307, the image forming apparatus 10 determines whether or not the forwarding setting for the received data from the FAX with the password is set to “notify” based on the fax settings stored in the HDD 104, and transmits the password confirmation to the chat server 20 if the setting requires inputting the password.

In step S1308, the chat server 20 analyzes the password confirmation received from the image forming apparatus 10 in the chat processing unit 201 of the control unit 200 and creates the chat message about the password confirmation based on the dialogue data 211. In step S1309, the chat server 20 transmits the chat message about the password confirmation created in step S1308 to the terminal device 30.

In step S1310, the terminal device 30 receives the password confirmation message from the chat server 20 in the chat processing unit 301 of the control unit 300. The control program 311 of the storage unit 310 also starts the chat application, and displays the chat message (the above password confirmation message) received from the chat server 20 on the display unit 320 as the message 1203 of FIG. 12A.

In step S1311, the terminal device 30 receives the password input by the user from the display unit 320 as the message 1204 of FIG. 12A. The contents of the password input are analyzed by the chat processing unit 301 of the control unit 300 to create the password input notification. In step S1312, the terminal device 30 transmits the password input notification created in step S1311 to the chat server 20.

In step S1313, the chat server 20 analyzes the password input notification received from the terminal device 30 in the chat processing unit 201 of the control unit 200 and transmits the password input notification to the image forming apparatus 10.

In step S1314, the image forming apparatus 10 analyzes the password input notification received from the chat server 20 in the CPU 101 and determines whether or not the password input by the user matches the preset password. FIG. 13A describes the case where the password matches the preset password. In step S1315, the image forming apparatus 10 determines that the password matches the preset password in step S1314 above, and executes the forwarding processing. In step S1316, the image forming apparatus 10 transmits to the chat server 20 that the forwarding has been completed as a result of the forwarding.

In step S1317, the chat server 20 analyzes the forwarding result received from the image forming apparatus 10 in the chat processing unit 201 of the control unit 200 and creates the chat message. In step S1318, the chat server 20 transmits the chat message about the forwarding result created in step S1317 to the terminal device 30.

In step S1319, the terminal device 30 receives the forwarding result message from the chat server 20 in the chat processing unit 301 of the control unit 300. The control program 311 of the storage unit 310 also starts the chat application, and the chat message (the forwarding result message described above) received from the chat server 20 is displayed on the display unit 320 as the message 1205 of FIG. 12A.

FIG. 13B illustrates a diagram showing a sequence in which the image forming apparatus 10 receives the data from the FAX that requires inputting the password during forwarding that meets the forwarding conditions, displays the received information and password confirmation on the chat application screen 800, and the password input by the user does not match the preset password. In the description of FIG. 13B, the chat application screen 800 of FIG. 12B is described as being displayed. Since steps S1320 to S1332 of FIG. 13B are the same processing as steps S1301 to S1313 of FIG. 9A, the description is omitted.

In step S1333, the image forming apparatus 10 analyzes the password input notification received from the chat server 20 by the CPU 101 and determines whether or not the password input by the user matches the preset password. FIG. 13B describes the case where the password input by the user does not match the preset password. In step S1334, the image forming apparatus 10 transmits the password reconfirmation to the chat server 20 because the password input by the user does not match the preset password.

In step S1335, the chat server 20 analyzes the password reconfirmation received from the image forming apparatus 10 in the chat processing unit 201 of the control unit 200 and creates the chat message about the password reconfirmation based on the dialogue data 211. In step S1336, the chat server 20 transmits the chat message about the password reconfirmation created in step S1335 to the terminal device 30.

In step S1337, the terminal device 30 receives the password reconfirmation message from the chat server 20 in the chat processing unit 301 of the control unit 300. The control program 311 of the storage unit 310 also starts the chat application, and the chat message (the password reconfirmation message described above) received from the chat server 20 is displayed on the display unit 320 as the message 1206 of FIG. 12B.

Thereafter, although not shown in FIG. 13B, the processing of steps S1330 to S1333 (the same processing as steps S1311 to S1314) is repeated. Then, if the password input by the user matches the preset password, the processing of steps S1315 to S1319 of FIG. 13A is performed, and the message 1208 of FIG. 12B is displayed on the chat application screen 800 of the terminal device 30.

Further, although not shown in FIG. 13B, the case where the processing of steps S1330 to S1333 (same processing as steps S1311 to S1314) is repeated, the password confirmation is performed, and the password input by the user does not match the preset password the predetermined number of times is described. In this case, the image forming apparatus 10 transmits the message to the chat server 20 indicating that the forwarding has failed. This message is transmitted to the terminal device 30 via the chat server 20 and is displayed on the chat application screen 800 of the terminal device 30 as a message prompting confirmation in the image forming apparatus 10 because the forwarding has failed, as shown in the message 1213 in FIG. 12C.

As described above, in the second embodiment, if the image forming apparatus 10 receives the data from the FAX that matches the forwarding conditions and requires inputting the password upon forwarding, the password confirmation is performed on the terminal device 30, and forwarding is performed only if the password input by the user matches the preset password. As a result, it becomes possible to properly execute the forwarding processing by the password and to report the forwarding result to the chat application of the terminal device 30. It should be noted that a message requesting the input of the password is posted on the chat service, but a message requesting the input of authentication information other than the password (for example, biometric authentication such as fingerprint authentication) may be posted on the chat service.

In each of the above embodiment, if the image processing apparatus receives the data from the FAX that requires the input of authentication information (such as a password) for processing the received data, the image processing apparatus receives the input of the authentication information using the chat application, and the received data is processed based on the authentication information. Therefore, even if receiving the data from the FAX requires the input of the authentication information for processing the received data, it is possible to appropriately perform the processing of the received data performed in cooperation with the chat application. Therefore, it is possible to solve the security issue in the image processing apparatus cooperated with the network communication service such as the chat application and improve the usability.

It is needless to say that the structure and contents of the various types of data described above are not limited to this, but may consist of various structures and contents according to the use and purpose. Although particular embodiments have been described above, embodiments of the present disclosure can be implemented as a system, apparatus, method, program, or storage medium, for example. Specifically, it can be applied to a system consisting of multiple devices, or it can be applied to an apparatus consisting of one device. In addition, all of the configurations combining the above respective embodiments are also included in the present disclosure.

According to embodiments of the present disclosure, it is possible to improve usability by solving security issues in an image processing apparatus cooperated with a network communication service.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-048092, filed Mar. 24, 2022, which is hereby incorporated by reference herein in its entirety.

What is claimed is:

1. An image processing apparatus receiving data from a facsimile, the image processing apparatus comprising:
one or more memories; and
one or more processors that execute instructions to:
post, to a message communication service, a message indicating that the data is received; and
perform processing of the data received from the facsimile,
wherein a message requiring an input of authentication information is posted according to a condition, and
wherein the processing of the data is performed based on the authentication information received via the message communication service.

2. The image processing apparatus according to claim 1, wherein a message indicating a content of the data is posted as the processing based on the authentication information.

3. The image processing apparatus according to claim 2, wherein the condition includes that an F-code is set in the data.

4. The image processing apparatus according to claim 1, wherein the processing includes forwarding the data to a predetermined destination.

5. The image processing apparatus according to claim 4, wherein the condition includes that the forwarded data is included in a predetermined forwarding condition and the forwarding processing in the image processing apparatus requires the input of the authentication information.

6. The image processing apparatus according to claim 4, wherein a message indicating a result of the forwarding processing is posted.

7. The image processing apparatus according to claim 1, wherein if an authentication based on the authentication information fails, a message requiring the input of the authentication information is posted again.

8. The image processing apparatus according to claim 7, wherein if the authentication fails a predetermined number of times, a message indicating that the processing of the data fails is posted.

9. The image processing apparatus according to claim 1, wherein the one or more processors further execute the instructions to:
set a first setting or a second setting, the first setting performing the input of the authentication information required for the processing of the data via the message communication service and the second setting not performing the input of the authentication information required for the processing of the data via the message communication service,
wherein a message requiring the input of the authentication information according to the condition is posted if the first setting is set,
wherein a message requiring the input of the authentication information according to the condition is not posted if the second setting is set.

10. A method of controlling an image processing apparatus receiving data from a facsimile, the method comprising:
posting, to a message communication service, a message indicating that the data is received;
posting, to the message communication service, a message requiring an input of authentication information according to a condition; and
performing the processing of the data based on the authentication information received via the message communication service.

11. A non-transitory computer-readable storage medium storing program to cause a computer to perform a method of controlling an image processing apparatus receiving data from a facsimile, the method comprising:
posting, to a message communication service, a message indicating that the data is received;
posting, to the message communication service, a message requiring an input of authentication information according to a condition; and
performing the processing of the data based on the authentication information received via the message communication service.
